(19) United States
(12) Patent Application Publication
(10) Pub. No.: US 2007/0263683 A1
(43) Pub. Date: Nov. 15, 2007

(54) OPTICAL APPARATUS AND IMAGE FORMING APPARATUS

(75) Inventor: Hiroshi NAKAHATA, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/745,080

(22) Filed: May 7, 2007

(30) Foreign Application Priority Data
May 12, 2006 (JP) 133907/2006

(51) Int. Cl. H01S 3/13; H01S 3/04; H01S 3/00

(52) U.S. Cl. 372/29.021; 372/36; 372/38.01; 372/29.014

(57) ABSTRACT

An optical apparatus includes a light source for emitting laser light perpendicularly to a surface of a semiconductor substrate; a positioning member for positioning the light source; an aperture stop defining an opening for limiting transmission of laser light emitted from the light source; a light detection member, provided on or close to the positioning member, for detecting an intensity of laser light; a reflection member, provided on the aperture stop, for reflecting the laser light from the light source toward the light detection member; and an adjusting means for adjusting an intensity of laser light emitted from the light source on the basis of a detection result of the light detection member.

### FIELD OF THE INVENTION AND RELATED ART

The present invention relates to control of an intensity of light of an optical apparatus in an image forming apparatus such as an electrophotographic copying machine, an electrophotographic printer, or the like apparatus.

An electrophotographic image forming apparatus provided with a plurality of image bearing members (photosensitive drums) has been conventionally used. In the image forming apparatus, on each of the photosensitive drums, a toner image formed fro, an electrostatic latent image which has been formed by irradiation with laser light is formed. Then, the resultant toner images are transferred onto a recording material in a superposition manner to form a color image.

A semiconductor laser used in a scanning type optical apparatus for irradiating a photosensitive drum with laser light will be described.

As a semiconductor laser used in an ordinary image forming apparatus, an edge emitting type semiconductor laser having a stacked layer structure including an n-side electrode 35, a substrate 36, a clad layer 37, an active layer 38, a clad layer 37, and a p-side electrode 39 as shown in FIG. 10 has been currently used. In such an electrophotographic image forming apparatus using the semiconductor laser, in order to obtain a stable image, stability of an intensity of laser light subjected to writing is required. In the edge emitting type semiconductor laser, a beam is emitted also in a rear surface direction opposite from a direction of a main beam, so that the beam emitted in the rear surface direction is detected by a photodiode incorporated in a package of the semiconductor laser. A photodiode current is converted into a light intensity signal through current-voltage conversion and on the basis of this light intensity signal, a drive current is feedback-controlled.

Next, a constitution of the edge emitting type semiconductor laser will be described with reference to FIG. 11. Referring to FIG. 11, the edge emitting type semiconductor laser includes a stem 40, an edge emitting type semiconductor laser device 41, a photodiode 42, a cover glass 43, and a metal-made cap 45. The device 41 outputs (emits) light in both of front and rear directions during light emission. The photodiode 42 receives a part of the outputted light, specifically receives a light beam outputted rearwardly to monitor an intensity of the outputted light. The device 41 and the photodiode 42 are mounted on the stem 40 and thereon, the cover glass 43 is provided on a front side of the device 41. On the cover glass 43, the cap 45 provided with an opening 44 as an output opening for light beam is disposed to cover the cover glass 43 to seal the device 41 and the photodiode 42.

In recent years, in order to achieve a high resolution and high productivity, a surface emitting type semiconductor laser capable of emitting a large number of beams starts to be used. This surface emitting type semiconductor laser is constituted by an n-side electrode 46, a substrate 47, a multi-layered semiconductor film 48, an electrically insulating film 49, and a p-side electrode 50 as shown in FIG. 12. The surface emitting type semiconductor laser is capable of freely disposing a large number of semiconductor lasers two dimensionally, so that it is possible to achieve the high resolution without sacrificing the productivity, as described above. However, the surface emitting type semiconductor laser, different from the above described edge emitting type semiconductor laser, does not output (emit) laser light in the rear surface direction, so that detection and control of the intensity of the laser light cannot be effected easily. With respect to the control of the laser light intensity in the surface emitting type semiconductor laser, the following methods have been proposed.

Japanese Laid-Open Patent Application (JP-A) Hei 08-330661 has proposed a method in which a part of laser beams emitted from surface emitting lasers are branched as a monitoring light by a beam splitter fixed at an light emitting portion of the surface emitting lasers and the monitoring light is detected by a light detector.

JP-A Hei 07-110450 has proposed a method in which a prism, a half mirror, and a light condensing means are disposed at an emission opening of light beams and each of parts of light beams which are branched by the half mirror and condensed by the light condensing means is caused to independently enter an associated sensor of a plurality of sensors.

JP-A Hei 04-116881 has proposed a method in which a semiconductor laser is coated with a high reflection material at a rear reflection surface thereof to prevent emission of laser light from the rear reflection surface and laser light which has not entered a converging lens is reflected by a reflection mirror to enter a light receiving device.

JP-A Hei 06-76349 has proposed a method in which a pair of reflection surfaces each formed in an elliptical shape with two focuses at positions of a laser and a light detector is provided in correspondence with two pairs of lasers and light detectors to permit individual output monitoring of overlapping beams.

JP-A Hei 10-303513 has proposed a method in which a beam deviated from an emission window is received by a light receiving device provided close to the emission window or a beam deviated from an emission window and reflected by a reflection surface provided close to the emission window is received by a light receiving device provided behind a laser chip.

JP-A 2004-87816 has proposed a method in which light reflected by a reflection mirror having an opening for emitting parallel light flux from a collimator lens is received by a photodiode provided behind a semiconductor laser chip.

JP-A Hei 06-309685 has proposed a method in which a light receiving device is provided close to a periphery of a laser light emission window portion and ambient light in front radiation light of laser light emitted from a semiconductor laser apparatus is received by a light receiving device.

As described above, the conventional surface emitting type semiconductor lasers detect a part of light outputted for image formation by using an optical means such as a half mirror or the like in order to detect and control a light intensity thereof. In other words, the semiconductor lasers have a constitution in which an optical part (member) which is not required for image formation is interposed in a path of light to be formed into an image on a photosensitive drum.

When such an optical member as the half mirror or the like for permitting light transmission is disposed in the light path, a higher laser output is required for providing a predetermined electric potential to the photosensitive drum through light exposure. This is because light directed toward the photosensitive drum is attenuated by an amount corresponding to a transmittance of the half mirror. Almost all the attenuated light has been conventionally reflected by the half mirror and utilized for light intensity control by the photodiode.

In the case of the above described light intensity detection method utilizing the half mirror, the photodiode is provided at a position different from that of a light emission portion. In such a case, in order to effect feedback control by detecting the light intensity, it is necessary to provide electrical wiring connecting the photodiode to the light emission portion in addition to wiring on a substrate, so that such a constitution is not desirable from the viewpoint of radiation noise. For this reason, the photodiode may desirably be configured to be disposed in the neighborhood of the light emission portion and mounted on a laser drive circuit board (substrate).

### SUMMARY OF THE INVENTION

A principal object of the present invention is to provide a light scanning apparatus capable of detecting an intensity of light with no influence on imagewise light exposure and with an easy constitution of wiring.

According to an aspect of the present invention, there is provided an optical apparatus comprising:

a light source for emitting laser light perpendicularly to a surface of a semiconductor substrate;

a positioning member for positioning the light source;

an aperture stop defining an opening for limiting transmission of laser light emitted from the light source;

a light detection member, provided on or close to the positioning member, for detecting an intensity of laser light;

a reflection member, provided on the aperture stop, for reflecting the laser light from the light source toward the light detection member; and

adjusting means for adjusting an intensity of laser light emitted from the light source on the basis of a detection result of the light detection member.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic perspective view for illustrating a constitution of a laser unit in an embodiment of the present invention.

FIGS. 2(a) and 2(b) are schematic perspective views for illustrating a cross section of the laser unit in the embodiment of the present invention.

FIGS. 3(a) and 3(b) are schematic views for illustrating a light emission portion and a light detection portion in the embodiment of the present invention.

FIGS. 4, 5(a) and 5(b) are schematic sectional views of the laser unit in the embodiment of the present invention.

FIG. 6 is a schematic view for illustrating an image forming apparatus.

FIG. 7 is a schematic view for illustrating a scanning type optical apparatus.

FIG. 8 is a graph showing a laser current-laser light intensity characteristic.

FIG. 9 is a diagram for illustrating a light intensity adjusting means.

FIG. 10 is a schematic view for illustrating a constitution of a light emission portion of an edge emitting type semiconductor laser.

FIG. 11 is a schematic view for illustrating a constitution of the edge emitting type semiconductor laser.

FIG. 12 is a schematic view for illustrating a constitution of a surface emitting type semiconductor laser.

### DETAILED DESCRIPTION OF THE PREFERRED EMBODIMENTS

The present invention will be described more specifically based on embodiments with reference to the drawings. Dimensions, materials, shapes, and relative locations of constituents of the present invention are not limited to those described in the following embodiments unless otherwise specified.

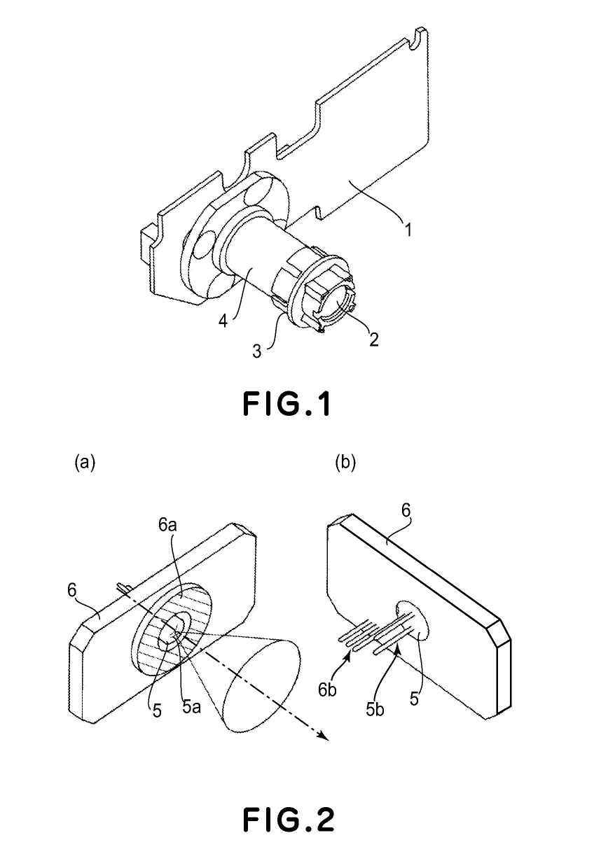

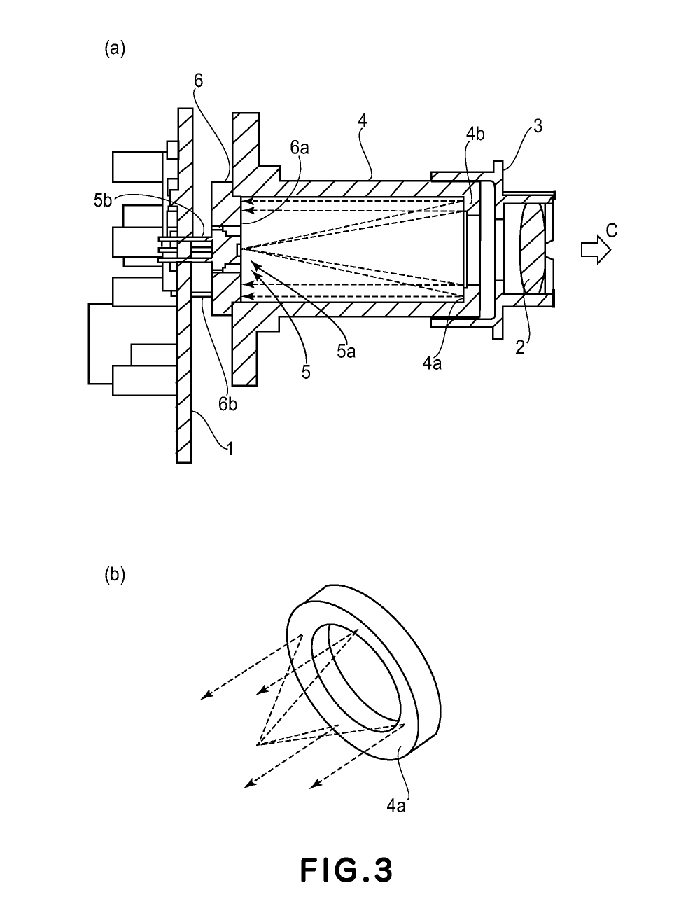

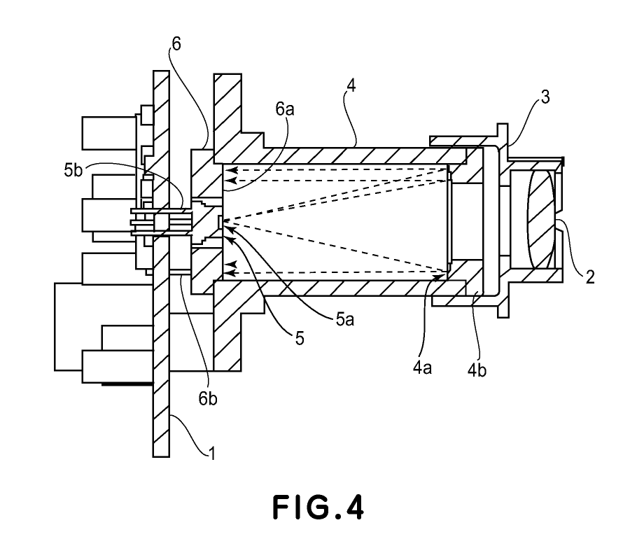

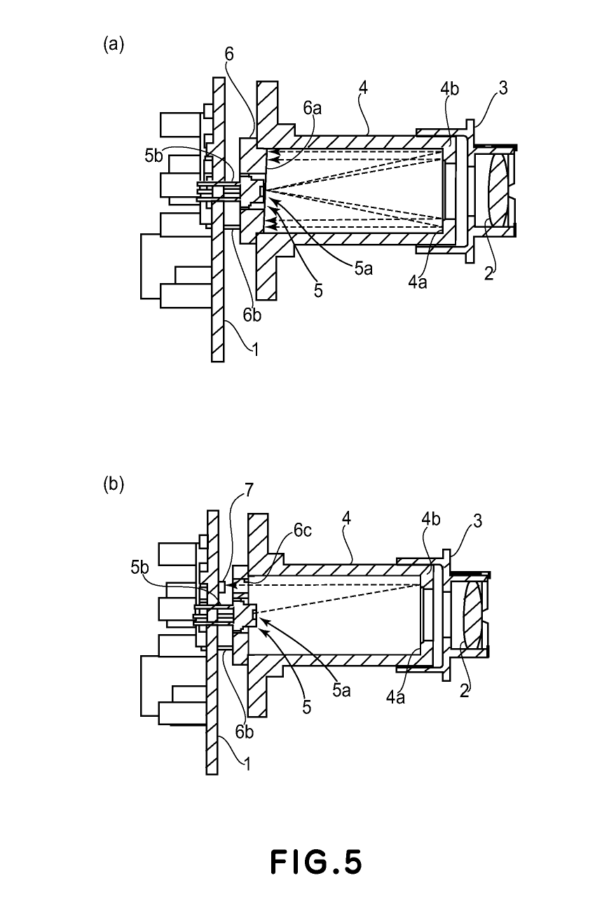

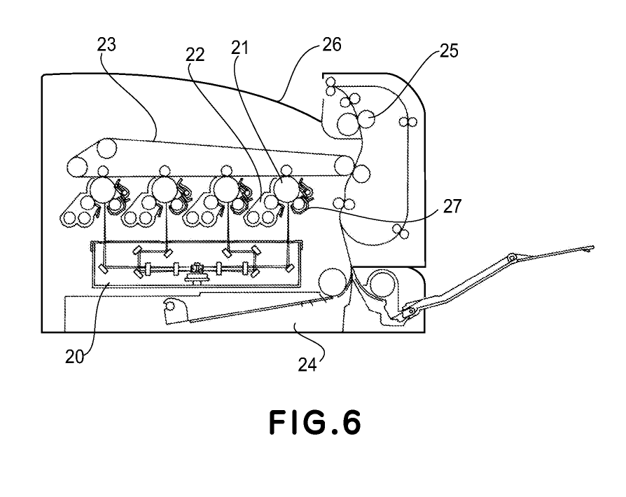

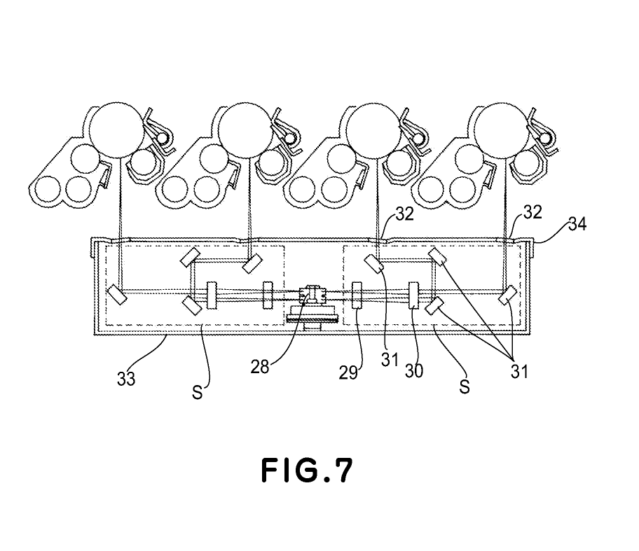

FIGS. 1 to 5 show a laser unit according to an embodiment of the present invention. More specifically, FIG. 1 is a schematic perspective view for illustrating a constitution of a laser unit in the embodiment. FIGS. 2(a) and 2(b) are schematic perspective views for illustrating a cross section of the laser unit in this embodiment. FIGS. 3(a) and 3(b) are schematic views for illustrating a light emission portion and a light detection portion in this embodiment. FIGS. 4, 5(a) and 5(b) are schematic sectional views of the laser unit in this embodiment. FIG. 6 is a schematic view for illustrating an image forming apparatus. FIG. 7 is a schematic view for illustrating a scanning type optical apparatus.

First, an electrophotographic image forming apparatus will be described with reference to FIGS. 6 and 7. FIG. 6 shows an image forming apparatus, for printing (forming) a color image, provided with independent image bearing members (photosensitive drums) for colors of yellow, magenta, cyan, and black. Each of the photosensitive drums is prepared by forming a photosensitive layer on an electroconductive member through wet coating and forms an electrostatic latent image by laser light emitted from a scanning type optical apparatus described below.

The image forming apparatus includes a scanning type optical apparatus 20 for emitting laser light on the basis of image information sent from an unshown image reading apparatus, personal computer, or the like; a photosensitive drum 21 for forming thereon an electrostatic latent image by exposure to the laser light emitted from the scanning type optical apparatus 20; a developing device 22 for forming a toner image on the photosensitive drum 21 with triboelectrically charged toner; an intermediary transfer belt 23 for transferring the toner image from the photosensitive drum 21 onto a recording material; a sheet feeding cassette 24 for accommodating and feeding the recording material on which the toner image is to be formed; a fixing device 25 for fixing the toner image transferred onto the recording material under heating; a sheet discharge tray 26 for mounting thereon the fixed recording material; and a cleaner 27 for removing the toner remaining on the photosensitive drum 21.

For image formation, first, an electrostatic latent image is formed on the photosensitive drum 21 electrically charged by a charger by irradiating the photosensitive drum 21 with laser light emitted from the scanning type optical apparatus 20 on the basis of image information. Thereafter, a toner image is formed on the photosensitive drum 21 by depositing toner triboelectrically charged in the developing device 22 on the electrostatic latent image. The toner image is transferred from the photosensitive drum 21 onto the intermediary transfer belt 23 and further transferred onto the recording material fed from the sheet feeding cassette 24 disposed at a lower portion of a main assembly of the image forming apparatus to form an image on the recording material. The recording material on which the image is formed is subjected to fixing of the image by the fixing device 25 to be discharged and mounted on the sheet discharge tray 26.

FIG. 7 is an enlarged view of the image forming portion of the image forming apparatus shown in FIG. 6. The scanning type optical apparatus 20 has a bilateral (left-right) symmetry shape, so that reference numerals are basically shown a right-hand portion. The scanning type optical apparatus 20 employs a method in which two laser light beams enter a single rotary polygon mirror 28 on each of both sides and used for exposing four photosensitive drums 21 to associated laser light beams, respectively. The scanning type optical apparatus 20 includes the polygon mirror 28, fθ lenses 29 and 30, a plurality of folding mirrors 31, a dust-proof glass 32, an optical box 33, and a top cover 34 and employs a constitution in which the electrostatic latent image is formed on the photosensitive drums 21 with the laser light. The polygon mirror 28 effects polarization scanning with the laser light emitted on the basis of image information. The fθ lenses 29 and 30 effect constant speed scanning with the laser light and causes the laser light to be formed into a spot image on the photosensitive drums 21. The folding mirrors 31 reflect the laser light beams in predetermined directions. The dust-proof glass 32 protects the scanning type optical apparatus 20 from dust. The optical box 33 is blocked from the outside by the top cover 34 after the respective optical elements are incorporated therein.

The scanning type optical apparatus has been changed in location, with downsizing of a main assembly thereof, from a conventional emission position spaced apart from the photosensitive drum to a position closer to the photosensitive drum. In the conventional scanning type optical apparatus, a method in which four photosensitive drums are irradiated with laser light by a single polygon motor unit is employed. Further, two scanning groups S (shown in FIG. 7) for irradiating the photosensitive drums with a plurality of laser light beams are formed on both sides of the polygon mirror.

Further, in order to ensure downsizing of the unit, the plurality of folding mirrors are used. In addition, in order to form an image on the photosensitive drum with each of laser light beams having different two optical paths, two lenses are bonded to each other or a mold lens integrally formed so as to ensure two optical paths is used.

A laser unit as the scanning type optical apparatus according to this embodiment includes a laser substrate 1, a collimator lens 2, a collimator lens holder 3, a laser holder 4, a surface emitting type semiconductor laser 5, and a photodiode 6. This laser unit drives laser light emitted from the semiconductor laser 5 as a light source and covers the laser light into collimated light or beams (parallel light) C (indicated by an arrow in FIG. 3(a)). The laser unit is used for forming an electrostatic latent image on the photosensitive drum by irradiating the photosensitive drum with the collimated light on the basis of image data in an image forming apparatus such as an electrophotographic copying machine, an electrophotographic printer, or the like.

The laser substrate 1 controls light emission from the semiconductor laser 5 on the basis of the image data and effects feedback control of an intensity of light on the basis of a light intensity signal from the photodiode. The collimator lens 2 converts the laser light emitted from a laser light emitting device (not shown) of the semiconductor laser 5 into the collimated light C. The collimator lens holder 3 holds the collimator lens 2 and is adhesively fixed to the laser holder 4 after being adjusted so as to permit the conversion of the laser light emitted from the semiconductor laser 5 into the collimated light C. The laser holder 4 as a holding member holds the collimator lens holder 3 and the photodiode unit 6.

Next, with reference to FIG. 2, constitution of the semiconductor laser 5 and the photodiode unit 6 will be described. The photodiode unit 6 as a light detection portion mounts thereon a doughnut-like photodiode 6a as a sensor surface as indicated by a hatched line in FIG. 2(a). FIG. 2(a) is a front perspective view, wherein laser light is diffusively emitted in an elliptical shape from a laser emission portion 5a of the semiconductor laser 5. In this embodiment, the photodiode unit 6 a positioning member which directly holds the semiconductor laser 5 and determines a position of the semiconductor laser 5. Accordingly, as shown in FIG. 2(b), output pins 5b and 6b of the semiconductor laser 5 and the photodiode unit 6 are constituted so as to be exposed together in a close state and are mounted together to the laser substrate 1.

FIG. 3(a) is a sectional view of the laser unit shown in FIG. 1 and FIG. 3(b) is a partially enlarged view thereof. As shown in FIG. 3(a), the semiconductor laser 5 emits a plurality of laser light beams from the laser emission portion 5a. The photodiode unit 6 mounts the photodiode 6a for detecting an intensity of laser light emitted from the semiconductor laser 5 at its front surface portion. The semiconductor laser 5 is press-fitted (fixed) in the photodiode unit 6, which is held by the laser holder 4 to keep the light source at a predetermined position.

The surface emitting type semiconductor laser 5 which emits the laser light perpendicularly to the surface of the semiconductor substrate does not radiate the laser light in a rear surface direction, so that it is necessary to detect light emitted in a laser light emission direction, i.e., a direction toward the collimator lens 2 by some method. In the laser unit 4 according to this embodiment, the positioning member 6 for determining the position of the light source and an aperture stop member 4 having an opening (aperture) for limiting passage of the laser light are constituted so as to be integrally movable. Further, the laser unit 4 holds the collimator lens 2. The aperture stop member 4b has a doughnut-like concave reflection portion 4a, on its inner wall as a reflection member constituted optically so that the laser emission portion 5a of the semiconductor laser 5 is a focus. The concave reflection portion 4a does not have a reflection surface at its opening through which the laser light passes and enters the collimator lens 2, and reflects the laser light which does not pass through the collimator lens 2, i.e., the laser light which does not enter the collimator lens 2 but is conventionally absorbed in the laser holder 4. Further, the concave reflection portion 4a is coated in a mirror surface state so as to have a high reflectance.

More specifically, the laser unit according to the present invention has a constitution in which the doughnut-like concave reflection portion 4a providing the focus at the laser emission portion 5a is provided at a periphery of the collimator lens 2 and the doughnut-like photodiode 6a for detecting the light intensity is provided at a periphery of the laser emission portion 5a. As shown in FIGS. 3(a) and 3(b), by providing the concave reflection portion optically constituted as described above to the laser holder 4, laser light beams which are as parts of the laser light emitted from the laser emission portion 5a of the semiconductor laser 5 and are located in an area in which the laser light beams do not pass through the collimator lens 2 are converted into parallel reflected light beams (as indicated by broken lines). That is, most of the laser light beams in a wide for field area are converted into parallel reflect light beams. The thus converted parallel reflected light beams enter the photodiode 6a.

FIG. 3(b) is a schematic enlarged view of the concave reflection portion 4a alone. As shown in FIG. 3(b), the laser light beams radiated from the focus are converted into the parallel reflected light beams with respect to the laser light beams at an entire peripheral portion and at all of the angles according to geometrical rule. For this reason, a large intensity of laser light enters the photodiode 6a, so that it is possible to properly keep detection accuracy (S/N ratio) of the photodiode 6a. Further, in an optical path of the laser light passing through the collimator lens 2, there is no optical member such as a half mirror or the like, so that it is possible to keep an optical efficiency at a high level without causing a lowering in light intensity. Further, the photodiode 6a and the semiconductor laser 5 are disposed at the same position with respect to a direction of the optical path of the reflected light and are connectable to the laser substrate 1, so that additional wiring is not required and this constitution is also advantageous in terms of noise.

The concave reflection portion 4a constituting the laser holder 4 may have a reflectance to such an extent that the laser light can enter the photodiode 6a. Accordingly, in order to obtain such a reflectance, the laser holder 4 may also be coated with a reflection film at an associated portion after being produced, thus having a high reflectance.

In the case where the reflectance at the sensor surface of the photodiode 6a is high, there is a possibility that the laser light reflected by the sensor surface enters again the laser emission portion 5a to destabilize laser light emission. In such a case, as shown in FIG. 5(a), it is possible to prevent the reflected laser light from the sensor surface to enter the laser emission portion 5a again by inclining the sensor surface of the photodiode 6a at a predetermined angle with respect to an axis of the laser light reflected by the concave reflection portion 4a. Further, the sensor surface may be coated with a reflection prevention film or the like to decrease a reflectance.

Further, the shapes of the photodiode 6a and the concave reflection portion 4a are not necessarily a substantially doughnut-like shape. For example, even by such a constitution that a reflection surface is formed only in an area in which a predetermined intensity of laser light is ensured, it is possible to achieve the same effect.

The semiconductor laser 5 is not necessarily press-fitted in the photodiode 6a but may also be fixed to the photodiode 6a by another fixing means without being press-fitted in the photodiode 6a. The photodiode 6a is not necessarily located at the same position as the semiconductor laser 5 with respect to the optical path direction of the reflected laser light. For example, as shown in FIG. 5(b), at a part of a positioning member, a light detection opening 6c is provided in an optical path of the reflected laser light so that the reflect laser light enters a photodiode 7 provided on the laser substrate 1, thus guiding a part of laser light reflected by the concave reflection portion 4a into the photodiode 7. Further, a light emission source need not be the surface emitting type semiconductor laser but may also be any light emission source so long as it does not easily detect the light intensity at its rear surface portion. In the latter constitution, it is possible to obtain a similar effect by employing the optical apparatus of the present invention.

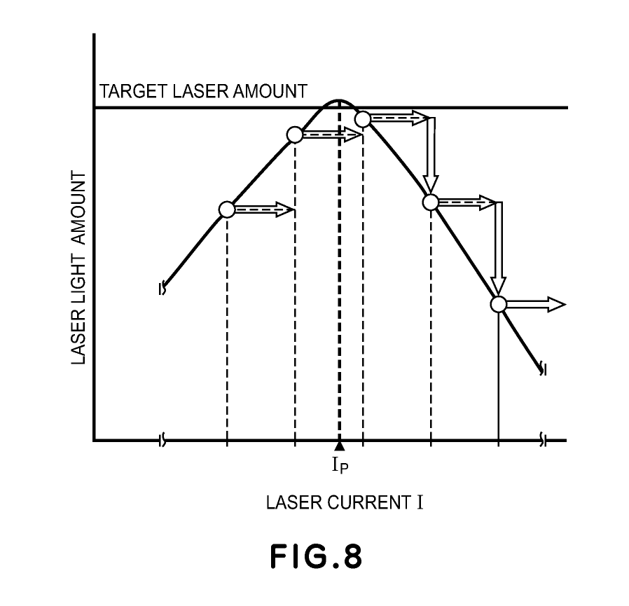

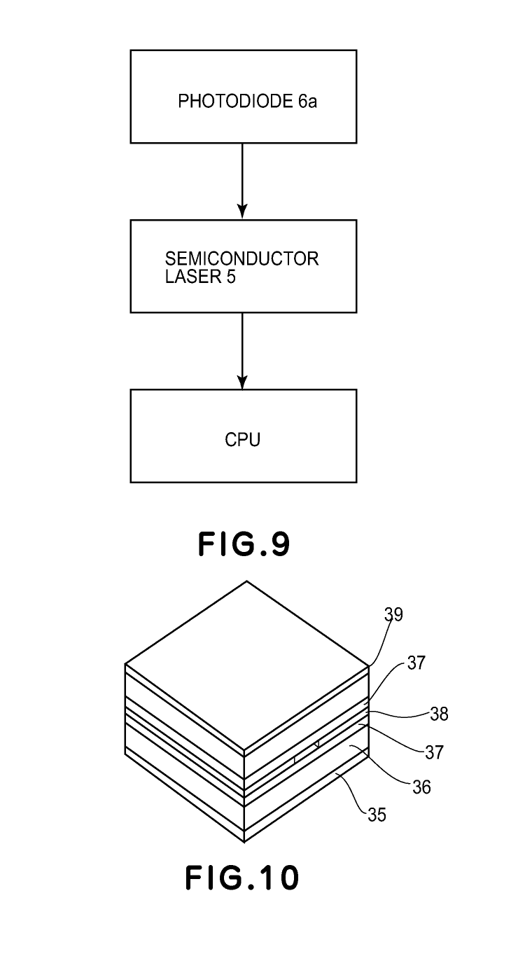

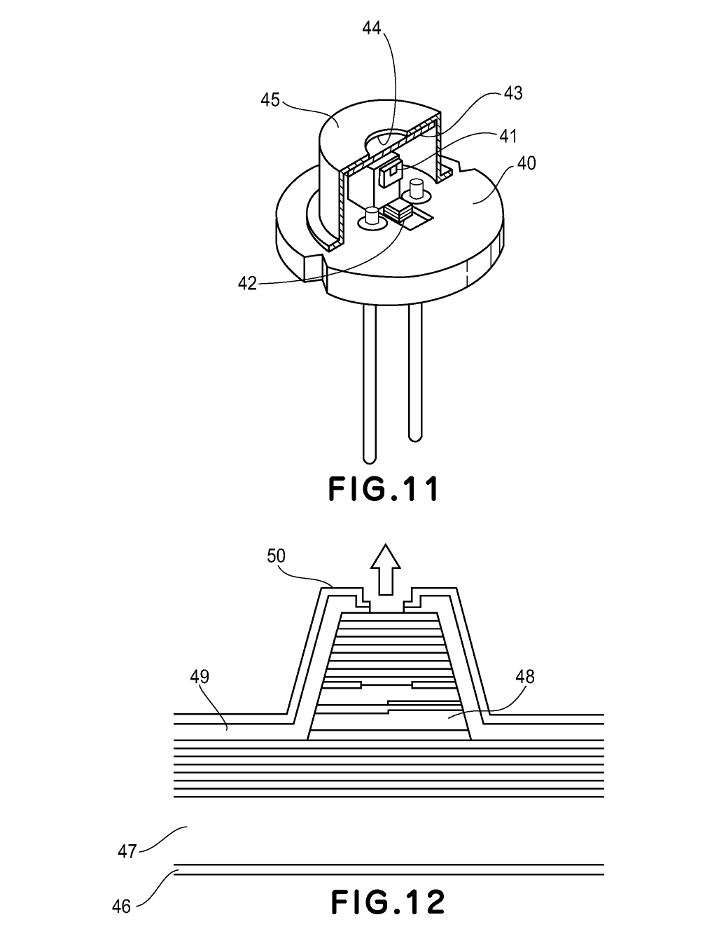

Adjustment of the light intensity will be described with reference to FIGS. 8 and 9. FIG. 8 is a graph showing a laser current-laser light intensity characteristic of the surface emitting type semiconductor laser. As will be understood from this characteristic, the light intensity can be adjusted by changing the laser current. In this embodiment, as shown in FIG. 9, the light intensity is adjusted by inputting a signal (light intensity detection signal) from the light intensity detection member into a CPU as a light adjusting means and then changing an amount of a laser current required for providing a target intensity of laser light by the CPU.

As described above, by disposing the substantially doughnut-like concave reflection portion 4a at a position providing the focus at the laser emission portion 5a of the semiconductor laser 5, it is possible to convert most of the laser light beams located in the wide far field area into the parallel reflected laser light beams. Further, it is possible to detect all the reflect laser light beams by disposing the photodiode 6a constituted in the substantially doughnut-like shape at the periphery of the laser emission portion 5a. According to the present invention, the following effects can be achieved.

First, it is possible to cause a large intensity of laser light to enter the photodiode 6a, so that it is possible to properly keep the detection accuracy of the photodiode 6a.

Further, by disposing the photodiode 6a close to the laser emission portion 5a, it is possible to ensure direct wiring of the semiconductor laser 5 and the photodiode unit 6 with the laser substrate 1. In other words, the semiconductor laser 5 and the photodiode unit 6 can be mounted on the same substrate, so that another wiring using bundle wire is not required and it is possible to ensure a high resistance to noise.

Further, in the present invention, most of the laser light emitted from the semiconductor laser 5 is effectively utilized and the optical member such as the half mirror or the like is not provided with respect to the laser light passing through the collimator lens 2, so that a lowering in light intensity does not occur. In other words, it is possible to enhance an optical efficiency of the laser light which passes through the collimator lens 2 and is subjected to image formation.

As described hereinabove, according to the present invention, with no influence an imagewise light exposure, it is possible to detect the light intensity with an easy constitution of wiring.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 133907/2006 filed May 12, 2006, which is hereby incorporated by reference.

What is claimed is:

1. An optical apparatus comprising:
a light source for emitting laser light perpendicularly to a surface of a semiconductor substrate;
a positioning member for positioning said light source;
an aperture stop defining an opening for limiting transmission of laser light emitted from said light source;
a light detection member, provided on or close to said positioning member, for detecting an intensity of laser light;
a reflection member, provided on said aperture stop, for reflecting the laser light from said light source toward said light detection member; and
adjusting means for adjusting an intensity of laser light emitted from said light source on the basis of a detection result of said light detection member.

2. An apparatus according to claim 1, wherein said reflection member has a shape which surrounds the opening, and wherein said light detection member has a shape which surrounds said light source attached to said positioning member.

3. An apparatus according to claim 1, wherein said optical apparatus further comprises an electric substrate for being electrically connected to said light source, and wherein said light detection member is electrically connected to said electric substrate.

4. An apparatus according to claim 3, wherein said light detection member is attached to said electric substrate, and wherein reflected laser light passes through a light detecting opening provided to said positioning member and travels toward said light detection member.

5. An apparatus according to claim 1, wherein said positioning member and said aperture stop integrally constitute a laser unit which holds a collimator lens.
